(19) United States
(12) Patent Application Publication
(10) Pub. No.: US 2013/0185204 A1
(43) Pub. Date: Jul. 18, 2013

(54) CONSOLIDATED CHECKING ACCOUNT AND CREDIT LINE

(71) Applicant: ROBERT MATTHEW IOBBI, Nottingham, MD (US)

(72) Inventor: ROBERT MATTHEW IOBBI, Nottingham, MD (US)

(21) Appl. No.: 13/554,916

(22) Filed: Jul. 20, 2012

Related U.S. Application Data
(60) Provisional application No. 61/510,701, filed on Jul. 22, 2011.

(51) Int. Cl. G06Q 40/02

(52) U.S. Cl. CPC G06Q 40/02
USPC 705/42

(57) ABSTRACT

A consolidated account may be created from several financial accounts such as checking accounts and bank loans. Deposits to one of the checking accounts may be applied to one of the bank loans which may minimize interest charges.

### CROSS REFERENCE TO RELATED APPLICATIONS

This application claims the priority benefit of provisional application No. 61/510,701, filed Jul. 22, 2011.

### BACKGROUND OF THE INVENTION

The present invention relates to financial accounts and, more particularly, to a consolidated checking account and credit line.

Conventional financial accounts may be set up as separate accounts. Such separate accounts may not achieve the benefits of consolidated accounts.

As can be seen, there is a need for a consolidated checking account and credit line.

### SUMMARY OF THE INVENTION

In one aspect of the present invention, a consolidated account comprises at least one loan; and at least one spending account, wherein a consumer deposits funds into the consolidated account, wherein the deposited funds are credited against the at least one loan, and wherein a balance of the at least one loan is increased when the deposited funds are used by the at least one spending account.

In another aspect of the present invention, a method comprises consolidating, using a computer, at least one loan, and at least one spending account into a consolidated account; and crediting funds a consumer deposits into the consolidated account against the at least one loan.

These and other features, aspects and advantages of the present invention will become better understood with reference to the following drawings, description and claims.

### BRIEF DESCRIPTION OF THE DRAWINGS

FIG. 1 illustrates a block diagram of a consolidated checking account according to an exemplary embodiment of the invention; and

FIG. 2 illustrates a flow chart of the consolidated checking account of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a system of banking that comprises a credit line provided to a customer by a sponsoring bank, a checking account and a credit/debit card. These instruments are consolidated so that customer's deposits into the system are used to reduce the balance of the credit line, thereby achieving a lower average daily balance and reduced interest cost of credit for the customer. The sponsoring bank also benefits by increasing capitol available for further lending.

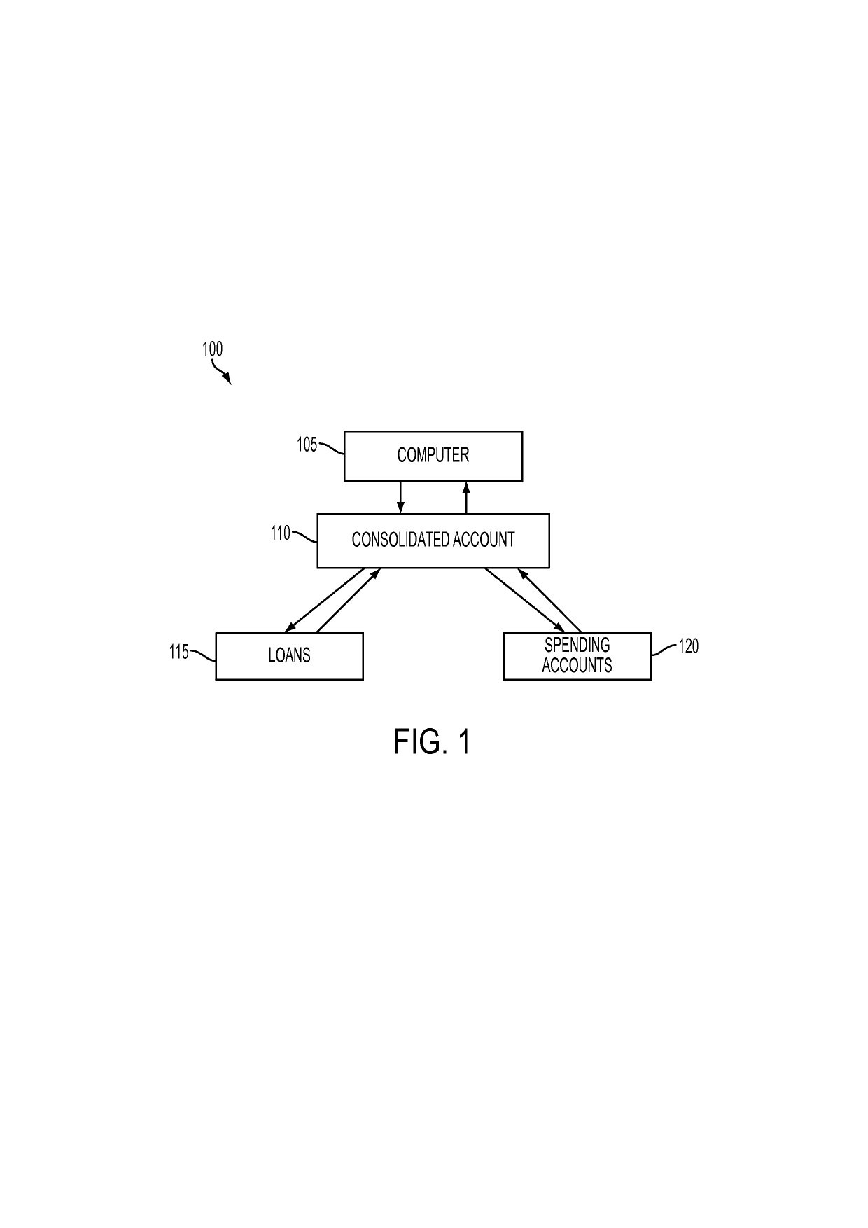

Referring to FIG. 1, a system 100 for servicing a consolidated account 110 may include a computer 105. Loans 115 and spending accounts 120 may be added to the consolidated account 110.

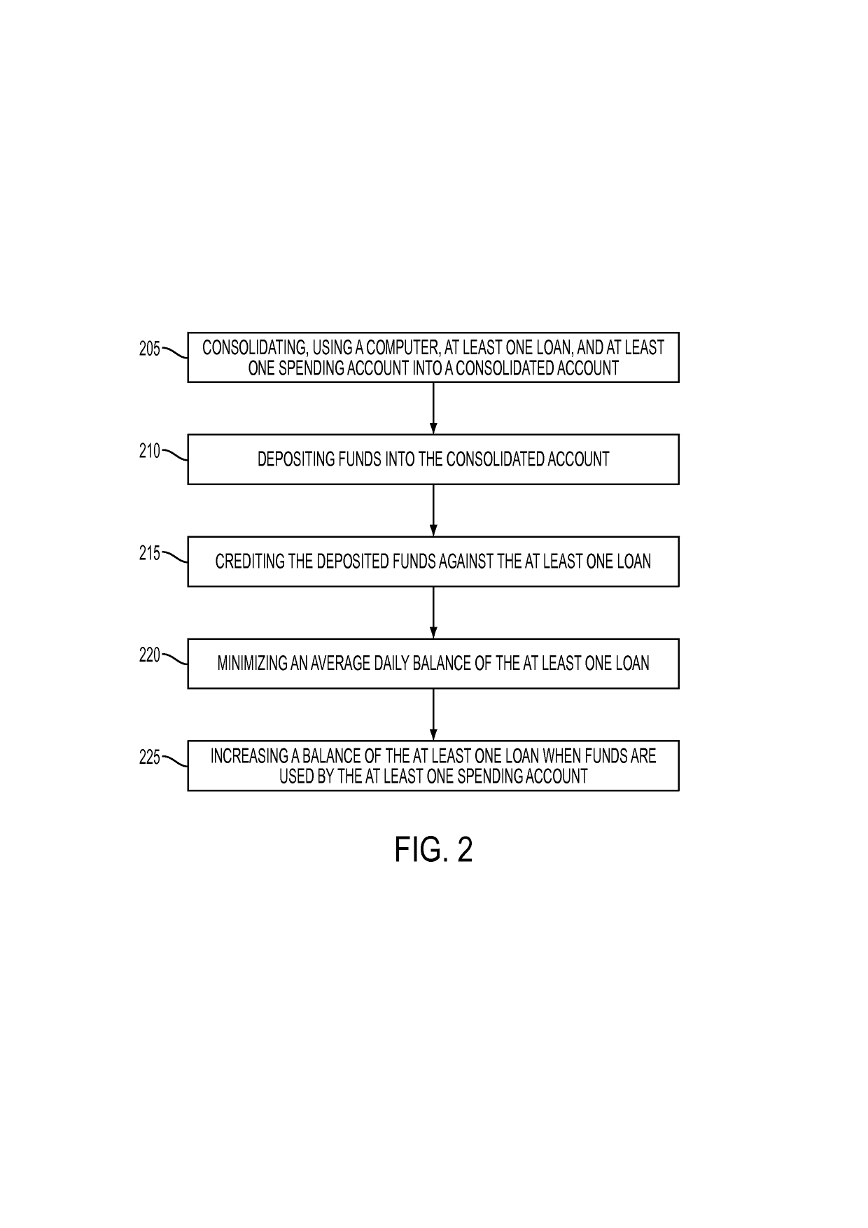

Referring to FIG. 2, the system 100 for servicing a consolidated account 110 may include a step 205 of consolidating, using the computer 105, at least one loan 115, and at least one spending account into a consolidated account 110 such as a checking account or savings account. A step 210 may include depositing funds into the consolidated account 110. A step 215 may include crediting the deposited funds against the at least one loan 115. A step 220 may include minimizing an average daily balance of the at least one loan 115. A step 225 may include increasing a balance of the at least one loan 115 when funds are used by the at least one spending account.

In an exemplary embodiment of the invention, a sponsoring bank may provide a customer with one of the loans 115, which can be an initial balance of extended credit, an auto loan, a home mortgage loan, a home improvement loan or a personal line of credit such as a credit card. The bank can also issue the consumer a spending instrument or spending account 120, which can be a checking account or a credit/debit card, and these spending instruments can be used to channel funds out of a single consolidated account 110. The customer can make regular deposits into the consolidated account 110 to reduce the balance of the one of the loans 115 or credit line, as well as writing checks or using a credit/debit card to spend funds from the account and increase the balance of the one of the loans 115 or credit line.

For example, a consumer can start his account with a $15,000 line of extended credit having an interest rate of 10%. He may make monthly deposits of $5,000 and spend $4,000 using his checking account. After one month, his credit line would then have a $14,000 balance. The consumer can thereby pay interest on a lower average daily balance because of the regular deposits and a reduction of the overall credit balance. Repeating the example would accelerate the debt reduction to a 17-month payoff, significantly reducing the interest cost of the debt. The savings result from the fact that the consumer's deposits go directly to loan payoff and not into a no-interest or low-interest checking account. The aforementioned 10% is a hypothetical example. The sponsoring bank may actually set the interest rate.

A consumer who may choose to pay off his credit card balance and effectively get an interest-free one of the loans 115 would benefit in the same way. However, an additional benefit to this type of consumer could be the flexibility of not having to pay the account off every month yet still being able to avoid the interest that can be incurred by carrying the debt into the following month.

The system can benefit not only those consumers who have expendable income, but those with other income and spending patterns. For example, in those months where a consumer's spending may be greater than his deposits, he can still benefit by avoiding a minimum monthly payment obligation on the extended credit. The constant deposits may be calculated as principal payments. Even if the interest rate on the described account may be three times higher than an alternative credit line, it could still be far more advantageous for the consumer to use the consolidated accounts 110 according to the invention. The consumer can leverage his income: the lower the interest rate the greater the benefit.

This system can benefit the consumer because it can avoid a current deficiency of the banking system in which consumers deposit their income into a checking account and spend from that account as necessary. These deposited funds may not work to the consumer's advantage, because he may not receive enough return on his deposited funds. Many consumers may also have a credit card debt or revolving credit account and pay only the minimum payments or small increments of acceleration each month. Consumers may currently pay high interest and fees on credit and revolving credit accounts. It may be essential for a consumer to have money in a bank that can be readily available for electronic transactions. However, in the scenario described, only the bank can benefit from the deposited capital.

Using the consolidated account 110 system 100 of the invention can provide the opportunity for consumers to benefit from their financial assets while enjoying the advantages of storing their money in a bank by consolidating a checking account with a credit line account. Both the checking account ledger and credit line can function as one where the consumer's deposits are leveraged against the credit line debt. The regular deposits can be constantly working to reduce the cost of the of the credit debt. The regular deposits may be calculated as principal payments to eliminate any minimum payment requirements on the credit account. For example, there may be no minimum monthly deposit to the consolidated account 110. The regular payments may accelerate the debt payoff through compound reductions of the debt.

The system can provide an attractive banking solution for the working class consumer while attracting new customers for a bank. In this system the bank can still benefit from an increase in capital. Further, the consolidated account 110 system 100 can reduce lending default risk to participating consumers thus improving the overall well being of the sponsoring financial institution for the following reasons: When a bank lends money in any manner, there may always be an associated risk of default. Guidelines governing lending practices may be determined by risk of default. That said, for a consumer to achieve the maximum rate of return on their account, direct deposit of income should be considered (this maybe a direct requirement of participation). When the constant deposit of residual income can be calculated as principal payments, the account may not have a minimum monthly payment obligation (this will be the biggest draw to consumers) and can thus drastically reduce the default risk on the extended credit.

It should be understood, of course, that the foregoing relates to exemplary embodiments of the invention and that modifications may be made without departing from the spirit and scope of the invention as set forth in the following claims.

1. A consolidated account comprising:
at least one loan; and
at least one spending account,
wherein a consumer deposits funds into the consolidated account,
wherein the deposited funds are credited against the at least one loan, and
wherein a balance of the at least one loan is increased when the deposited funds are used by the at least one spending account.

2. A method comprising:
consolidating, using a computer, at least one loan, and at least one spending account into a consolidated account; and
crediting funds a consumer deposits into the consolidated account against the at least one loan.

3. The method of claim 2, including minimizing an average daily balance of the at least one loan.

4. The method of claim 2, wherein the at least one spending account includes a checking account, and a savings account.

5. The method of claim 2, wherein there is no minimum monthly deposit to the consolidated account.

6. The method of claim 2, wherein the at least one loan is without a minimum monthly payment.

7. The method of claim 2, wherein the at least one loan includes an automobile loan, a home improvement loan, a home mortgage loan, and a credit card account.
